(19) United States
(12) Patent Application Publication
(10) Pub. No.: US 2020/0210142 A1
(43) Pub. Date: Jul. 2, 2020

(54) METHOD AND APPARATUS FOR CONTROLLING VIRTUAL SPEECH ASSISTANT, USER DEVICE AND STORAGE MEDIUM

(71) Applicant: BAIDU ONLINE NETWORK TECHNOLOGY (BEIJING) CO., LTD., Beijing (CN)

(72) Inventors: Yang MU, Beijing (CN); Qing LIU, Beijing (CN); Jianchao GAO, Beijing (CN)

(21) Appl. No.: 16/728,355

(22) Filed: Dec. 27, 2019

(30) Foreign Application Priority Data
Dec. 29, 2018 (CN) 201811642816.9

(51) Int. Cl. G06F 3/16; G06F 3/0481; G06F 3/0484; G10L 15/22

(52) U.S. Cl. CPC G06F 3/167; G06F 3/04817; G10L 2015/223; G10L 15/22; G06F 3/04845

(57) ABSTRACT

The present disclosure discloses a method and an apparatus for controlling a virtual speech assistant, a user device and a storage medium, which solves the problem associated with bad feedback effect for input of a user device in the field. The method includes: displaying a virtual speech assistant icon in a floating way on a human-machine interaction interface of a user device; receiving a speech instruction when a microphone of the user device is enabled; and performing an operation according to the speech instruction, and producing a speech output corresponding to an operation result of the operation.

### CROSS REFERENCE TO RELATED APPLICATION

This application claims priority under 35 U.S.C. § 119(a) to Chinese Patent Application No. 201811642816.9, filed with the State Intellectual Property Office of P. R. China on Dec. 29, 2018, the entire contents of which are incorporated herein by reference.

### TECHNICAL FIELD

The present disclosure relates to the field of electronic information technology, and more particularly to a method and an apparatus for controlling a virtual speech assistant, a user device and a storage medium.

### BACKGROUND

As people's living standard improves, the level of intelligence in a user device is also getting higher and higher. However, an execution result may not be fed back effectively for the input to the user device. The user also needs to view the execution result, which affects user's experience.

### SUMMARY

An object of the present disclosure is to provide a method and an apparatus for controlling a virtual speech assistant, a user device and a storage medium to overcome the problem of poor feedback for input of a user device in the related art. By displaying a virtual speech assistant icon in a human-machine interaction interface of the user device, convenience of speech manipulation may be improved and a frequency that a user uses speech manipulation may be increased.

In order to implement the above objects, a first aspect of embodiments of the present disclosure provides a method for controlling a virtual speech assistant. The method includes: displaying a virtual speech assistant icon in a floating way on a human-machine interaction interface of a user device; receiving a speech instruction when a microphone of the user device is enabled; and performing an operation according to the speech instruction, and producing a speech output corresponding to an operation result of the operation.

Alternatively, after receiving the speech instruction, the method further includes: displaying a dialog box in the floating way, and displaying a text corresponding to the speech instruction in the dialog box.

Alternatively, performing the operation according to the speech instruction and producing the speech output corresponding to the operation result of the operation includes: performing the operation according to the speech instruction; and producing the speech output corresponding to the operation result of the operation, and displaying the virtual speech assistant icon dynamically according to the operation result.

Alternatively, the method further includes: displaying the virtual speech assistant icon dynamically according to a setup of a preset reminder message when the user device is enabled, in which, the preset reminder message includes at least one of a festival, a solar term, news or weather information

Alternatively, the virtual speech assistant icon is displayed in a set area of the human-machine interaction interface.

Alternatively, the method further includes: hiding or half-hiding the virtual speech assistant icon when an instruction for dragging the virtual speech assistant icon out of the set area is received; and displaying the virtual speech assistant in the set area when a hiding-cancelling instruction is received.

Alternatively, the method further includes: displaying the virtual speech assistant icon dynamically when no speech instruction is received within a preset period.

Alternatively, displaying the virtual speech assistant icon dynamically includes displaying at least one of expression changes, movement changes, changes of clothes, or a bubble of the virtual speech assistant icon.

Correspondingly, a second aspect of embodiments of the present disclosure provides an apparatus for controlling a virtual speech assistant. The apparatus is configured to execute the method for controlling a virtual speech assistant described above.

Correspondingly, a third aspect of embodiments of the present disclosure provides a user device. The user device includes a microphone, a speech broadcast apparatus, a processor and a computer program stored in a memory and operated by the processor. The microphone is configured to obtain a speech instruction. The speech broadcast apparatus is configured to produce a speech output corresponding to an operation result of an operation. The processor is configured to implement the method for controlling a virtual speech assistant described above when executing the program.

Correspondingly, a fourth aspect of embodiments of the present disclosure provides a storage medium having instructions stored thereon that, when executed by a computer, causes the computer to implement the method for controlling a virtual speech assistant described above.

With the above technical solution, the virtual speech assistant icon is displayed in the floating way on the human-machine interaction interface of the user device; the speech instruction is received when the microphone of the user device is enabled; and the operation is performed according to the speech instruction, and the speech output corresponding to the operation result of the operation is produced. Embodiments of the present disclosure solve the problem that there is a bad feedback effect for input of the user device in the related art, improve the convenience of speech manipulation and increase the frequency that the user uses speech.

Certain features and advantages of the present disclosure will be described in detail in the following detailed implementations.

### BRIEF DESCRIPTION OF THE DRAWINGS

The accompanying drawings are used to provide a further understanding for the present disclosure and to form a part of the specification, and are used together with the following detailed implementations to explain the present disclosure. These drawings are used to illustrate but not to limit the present disclosure. In the accompanying drawings:

FIG. 1 is a flow chart illustrating a method for controlling a virtual speech assistant according to embodiments of the present disclosure;

FIG. 2 is a schematic diagram illustrating a display position of a virtual speech assistant icon according to embodiments of the present disclosure;

FIG. 3 is a schematic diagram illustrating a display position of a virtual speech assistant icon when a dialog box is displayed in another embodiment of the present disclosure;

FIG. 4 is a schematic diagram illustrating a virtual speech assistant icon in a hidden state according to embodiments of the present disclosure;

FIG. 5 is a schematic diagram illustrating switching operation states of a virtual speech assistant icon provided by another embodiment of the present disclosure; and

FIG. 6 is a schematic diagram illustrating switching operation states of a virtual speech assistant icon in application provided by another embodiment of the present disclosure.

### DETAILED DESCRIPTION

Detailed description will be made to detailed implementations of the present disclosure with reference to the accompanying drawings. It should be understood that, the detailed implementations described herein are merely for describing and explaining the present disclosure, and are not intended to limit the present disclosure.

FIG. 1 is a flow chart illustrating a method for controlling a virtual speech assistant according to embodiments of the present disclosure. As illustrated in FIG. 1, the method includes the following steps.

At block 101, a virtual speech assistant icon is displayed in a floating way on a human-machine interaction interface of a user device.

At block 102, a speech instruction is received when a microphone of the user device is enabled.

At block 103, an operation is performed according to the speech instruction, and a speech output corresponding to an operation result of the operation is produced.

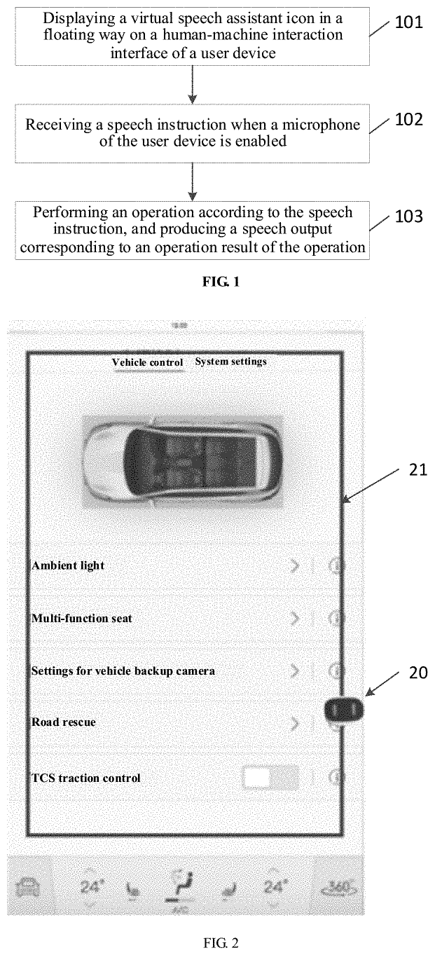

The virtual speech assistant icon is displayed in a set area of the human-machine interaction interface. For example, the virtual speech assistant icon may be displayed in a certain fixed area of the human-machine interaction interface, such as a lower right corner, or may be displayed at a frame of the human-machine interaction interface so as not to block other information on the human-machine interaction interface. As illustrated in FIG. 2, the virtual speech assistant icon 20 is displayed on a frame 21 of the human-machine interaction interface. Further, touch-based interactions of the icon may be implemented by clicking or dragging, such as a single click, multiple clicks, and dragging a full screen. In addition, the display position of the virtual speech assistant icon may be memorized such that when a user restarts the user device, the virtual speech assistant icon would still be displayed at a position where the user powers off the user device last time.

In addition, when the virtual speech assistant icon is displayed in the floating way on the human-machine interaction interface, a preset priority of the virtual speech assistant icon with respect to other application (APP) that is running on the human-machine interaction interface may be used for reference. When the priority of the virtual speech assistant icon is above that of the application that is running on the human-machine interaction interface, the virtual speech assistant icon may be displayed in a floating way on the human-machine interaction interface. On the other hand, when the priority of the virtual speech assistant icon is lower than that of the application that is running on the human-machine interaction interface, the application that is running on the human-machine interaction interface may be displayed by overlaying it over the virtual speech assistant icon. For example, when the user device is an on-vehicle terminal, on which a vehicle backup camera APP having a priority above that of the virtual speech assistant icon is running, the vehicle backup camera APP may be overlaid over the virtual speech assistant icon directly.

The virtual speech assistant icon includes five basic operation states, i.e., a stationary state, a monitoring state, an analyzing state, a broadcasting state and an abnormal state. The virtual speech assistant icon may be displayed in a unique dynamical display form in each of the above states.

When the user device is powered on, the virtual speech assistant icon enters the stationary state. The stationary state is a normal state, in which the microphone of the user device is in a disabled state.

Further, when the user device is enabled, the virtual speech assistant icon may be displayed dynamically according to settings for a preset reminder message. The preset reminder message may include at least one of a festival information, a solar term information, news or weather information. For example, the festival information may include information about national holidays, popular western holidays including but not limited to Valentine's Day, Mother's Day, Father's Day, Halloween, Christmas, Thanksgiving Day, etc. The solar term information may include information about 24 solar terms. The news may include subsequent on-topic stories of the news that have been read by the user, and hot news on the Internet. The weather information may include current weather information.

Further, the virtual speech assistant icon may be displayed dynamically with different clothes, movements, expressions, props or the like, according to the contents of the preset reminder message. For example, if today is National Day, the virtual speech assistant icon may be displayed by dressing a red clothes, waving a national flag, and providing a voice prompt “today is National Day”. If today is Christmas, the virtual speech assistant icon may be displayed by dressing a Santa Claus' costume, and playing a Christmas song to prompt. If today is Winter Solstice, the virtual speech assistant icon may be displayed by putting a plate of dumpling in the hand, and providing a voice prompt “Remember to eat dumplings at the Winter Solstice”. Alternatively, if a subsequent story of the news that have been read by the user is reported in today's news, the virtual speech assistant icon may be displayed by presenting an expression such as surprise, and prompting the user in voice. Alternatively, if it is reported in the weather forecast that there will be a heavy snow today, the virtual speech assistant icon may be displayed by dressing a thick coat, presenting movements and expressions showing very cold, and providing a voice prompt “There will be a heavy snow today. Remember to wear more” or other similar dynamical display. The above dynamical display forms may be presented in combination. For example, when today is Winter Solstice and a heavy snow is coming, the dynamical display may be presented by selecting any one of the above dynamical display forms, or may be presented sequentially in the order of priorities according to preset priorities of the preset reminder message. It should be noted that, the dynamical display forms of the virtual speech assistant icon are not limited to the above examples, and may include different dynamical display forms according to different contents of the preset reminder message, which will not be enumerated here.

When the microphone of the user device is enabled, the virtual speech assistant icon enters the monitoring state. In the monitoring state, the dynamical display form of the virtual speech assistant icon may be a gesture of listening carefully with a hand put behind the ear, or other dynamical display forms indicating that the virtual speech assistant icon is in the monitoring state. In the monitoring state, a speech instruction may be received, which may be analyzed in the analyzing state.

In the analyzing state, the analyzing process for the speech instruction may be performed in the user device locally. Alternatively, the speech instruction may be sent from the user device to a cloud server, which may analyze the speech instruction and send the analyzed result back to the user device. Then, the user device may perform a corresponding operation on the analyzed result, and produce a speech output corresponding to the operation result of the operation.

When the virtual speech assistant icon is in the analyzing state and in the broadcasting state, the virtual speech assistant icon may be displayed in three display forms, i.e., a floating display; dynamical display of the virtual speech assistant icon for the operation result; and a combination of the floating display and the dynamical display of the virtual speech assistant icon for the operation result.

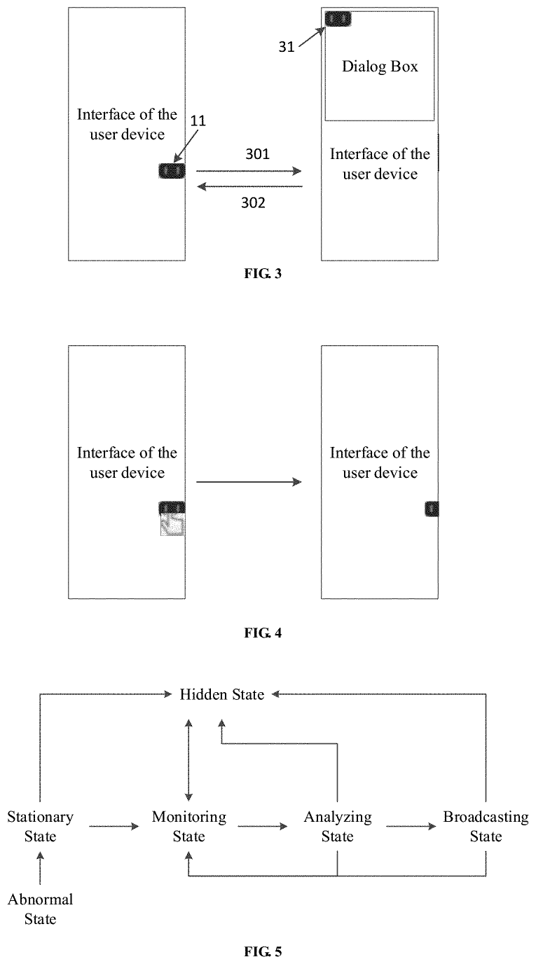

Specifically, in the first display form, i.e. the floating display, when the speech instruction is received, that is, a dialog stream appears, a dialog box is displayed in a floating way, in which a text corresponding to the speech instruction is displayed. A corresponding operation is performed according to the speech instruction. Then, a speech output corresponding to the operation result of the operation is produced. It is noted that when the dialog stream appears, the virtual speech assistant icon disappears from its original display position and moves to a speech state position. When the dialog stream ends, that is, the dialog box is no longer displayed, the virtual speech assistant icon moves back to its original position prior to the display of the dialog box. For example, as illustrated in FIG. 3, when the dialog box is displayed, at step indicated by the arrow 301, the virtual speech assistant icon disappears from its original display position 11 on the frame 21 of the human-machine interaction interface, and moves to a speech state position 31, e.g., near a language bar. On the other hand, when the dialog box is not displayed, at step indicated by the arrow 302, the virtual speech assistant icon moves back to its original display position 11 prior to the display of the dialog box. That is, the virtual speech assistant icon moves from the position 31 to the position 11. Moving trails for the change of positions of the virtual speech assistant icon may not be displayed in some embodiments.

In the second display form, i.e., the dynamical display of the virtual speech assistant icon for the operation result, the virtual speech assistant icon may show the operation result dynamically. When a speech instruction is received, an operation corresponding to the speech instruction may be performed. Then, a speech output corresponding to the operation result of the operation may be produced. Then, the virtual speech assistant icon may be displayed dynamically according to the operation result. For example, when the user device is an on-vehicle terminal, and the speech instruct from the user is “it is too hot in the vehicle”, a temperature of an air conditioner in the vehicle may be reduced according to the speech instruction. Further, a speech output “the temperature of the air conditioner is lowered for you”. In this case, the virtual speech assistant icon may present a movement showing “it is cool” or the like.

Alternatively, the embodiments according to the present disclosure may response to some emotional speech instructions or the like. For example, when the user says “how boring”, the user device may response to this speech instruction with a question “shall I play a piece of music for you”. At the same time, the virtual speech assistant icon may be displayed by wearing a headphone and making a dance movement of swinging left and right. When the user answers with “play the music”, a music that is played most frequently may be selected according to a historical play frequency. At the same time, the virtual speech assistant icon may be displayed by dancing according to a rhythm of the played music. The dynamical display forms of the virtual speech assistant icon are not limited to the above examples, and may include different dynamical display forms according to different contents of specific operation results.

In the third display form, i.e., the combination of the floating display and the dynamical display of the virtual speech assistant icon for the operation result, not only the dialog box is displayed, but also the virtual speech assistant icon is displayed dynamically. For example, the virtual speech assistant icon may be displayed dynamically at the speech state position 31 illustrated in FIG. 3 according to the operation result. Detailed display forms of the dialog box and the virtual speech assistant icon may refer to the above description for the first and second display forms.

The virtual speech assistant icon may enter the abnormal state when a fault in the microphone is detected, when the speech instruction cannot be obtained, when a system error occurs, or the like. When an abnormal status occurs, the user may be warned through the displayed movement, expression or clothes of the virtual speech assistant icon. For example, dynamical display forms in the abnormal state may include displaying an “x” on the mouse of the virtual speech assistant icon, or displaying an exclamation mark beside the virtual speech assistant icon, or other dynamical display forms, as long as it may warn or reminder the user. When the fault is removed, the virtual speech assistant icon may recover from the abnormal state to the stationary state.

In the embodiments of the present disclosure, the virtual speech assistant icon may be displayed in a hidden state, including a full-hidden state and a half-hidden state. The virtual speech assistant icon may be displayed in the full-hidden state or the half-hidden state when an instruction for dragging the virtual speech assistant icon out of the set area is received. For example, if the set area is a fixed area in the human-machine interaction interface, such as an area at the lower right corner of the human-machine interaction interface, when an instruction for dragging the virtual speech assistant icon out of the area at the lower right corner is received, the virtual speech assistant icon may be fully hidden, or only a half of the virtual speech assistant icon is displayed at an edge of the human-machine interaction interface, i.e., half hiding. Alternatively, when the virtual speech assistant icon is displayed on the frame 21 of the human-machine interaction interface, as shown in FIG. 2, the user may drag the virtual speech assistant icon towards outside of the screen. Then, as shown in FIG. 4, the virtual speech assistant icon may be fully or half hidden. Alternatively, in another embodiment, the virtual speech assistant icon may be fully or half hidden by receiving a speech instruction of hiding from the user; or, the virtual speech assistant icon may be half hidden by receiving a speech instruction of half-hiding from the user.

Further, to cancel the hidden state of the virtual speech assistant icon, the virtual speech assistant icon is displayed in the set area when a hiding-cancelling instruction is received. For the virtual speech assistant icon in the full-hiding state and that in the half-hiding state, the hiding-cancelling instructions may be different. For example, when the virtual speech assistant icon is in the full-hiding state, the hidden state of the virtual speech assistant icon may be cancelled through a manual cancellation operation or a speech instruction. Further, when the virtual speech assistant icon is in the half-hiding state, the half-hiding state may be cancelled by clicking the virtual speech assistant icon, dragging the virtual speech assistant icon towards inside of the screen, or by voice.

The switching between the operating states of the virtual speech assistant icon will be understood with reference to FIG. 5. When the abnormal state is removed, the virtual speech assistant icon may enter into the stationary state. When the microphone is enabled, and the virtual speech assistant icon is woken up by clicking a button on the device (such as a steering wheel button when the user device is an on-vehicle terminal) or by voice, the virtual speech assistant icon may enter into the monitoring state. Then, after a speech instruction is received, the virtual speech assistant icon may enter into the analyzing state for analyzing the speech instruction. The analyzed result may be broadcasted in speech. When the virtual speech assistant icon is in the analyzing state and the broadcasting state, the virtual speech assistant icon may re-enter the monitoring state may be re-entered when it is clicked. When the virtual speech assistant icon is in any one of the stationary state, the monitoring state, the analyzing state and the broadcasting state, the virtual speech assistant icon may enter into the hiding state (including the half-hiding state) through a set operation (such as dragging or speech control). After the hiding state (including the half-hiding state) is canceled, the virtual speech assistant icon enters into the monitoring state directly.

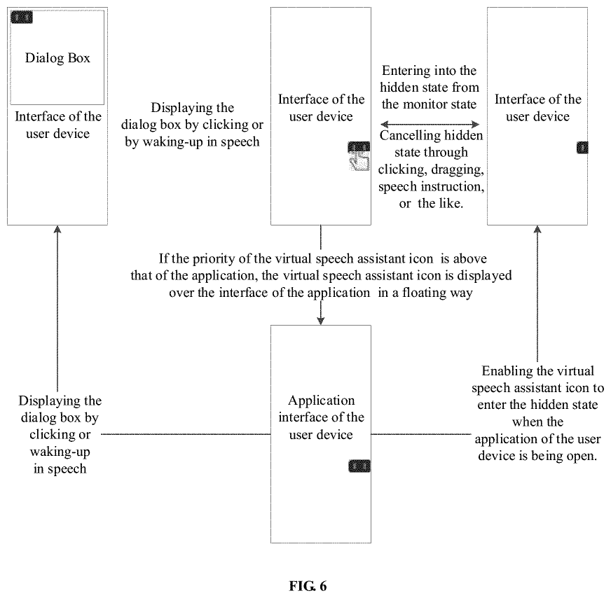

Further, in some embodiments, as illustrated in FIG. 6, when the virtual speech assistant icon is in the monitoring state (or the stationary state, the analyzing state, the broadcasting state), the virtual speech assistant icon maybe switched to the half-hiding state through a set operation (such as dragging or speech control) and maybe released from the hiding state through a user operation such as clicking or dragging or by voice. When the virtual speech assistant icon is in the monitoring state, a dialog box may be displayed by clicking or by waking-up in speech, to perform analysis on the speech instruction. When an application in the user device is open, if the priority of the virtual speech assistant icon is above that of the application, the virtual speech assistant icon may be displayed over the interface of the application in the floating way. When the interface of the application is displayed on the user device, the user may cause the virtual speech assistant icon to enter the half-hiding state through a set operation (such as dragging or speech control). The user is also allowed to display the dialog box by clicking or waking-up in speech, to perform the analysis on the speech instruction.

In another embodiment of the present disclosure, to enable the user to perform speech interaction actively, when no speech instruction is received within a preset period, the virtual speech assistant icon may be displayed dynamically. For example, when no speech instruction of the user is received within the preset period, and the user is switching among interfaces of different applications on the interface of the user device, the virtual speech assistant icon may be presented with different expressions during the switching. Alternatively, when the user device is the on-vehicle terminal, and it is detected that the vehicle is in a low-speed state (i.e., at N level or P level), or it is detected that the vehicle is at S level or D level and the speed of the vehicle is lower than a preset speed (such as 5 km/h), the virtual speech assistant icon may be presented with different clothes, so as to attract the user. Further, the virtual speech assistant icon may be presented with different expressions or movements when the virtual speech assistant icon is clicked or being dragged.

In the above embodiments, displaying the virtual speech assistant icon dynamically may include at least one of expression changes, movement changes, changes of clothes, or bubble display of the virtual speech assistant icon, which may be displayed individually or in combination with each other.

With embodiments of the present disclosure, the virtual speech assistant icon may be displayed on the human-machine interaction interface of the user device, which may solve the problem poor feedback for the input of the user device in the related art, improve convenience of speech manipulation, and increase the frequency that the user uses speech manipulation.

Correspondingly, embodiments of the present disclosure further provide an apparatus for controlling a virtual speech assistant. The apparatus is configured to execute the method for controlling a virtual speech assistant according to the above embodiments.

The operation process of the apparatus may refer to the above implementations of the method for controlling a virtual speech assistant.

Correspondingly, embodiments of the present disclosure provide a user device. The user device includes a microphone, a speech broadcast apparatus, a processor and a computer program stored in a memory and operated by the processor. The microphone is configured to obtain a speech instruction. The speech broadcast apparatus is configured to produce a speech output corresponding to an operation result of an operation. The processor is configured to implement the method for controlling a virtual speech assistant according to the above embodiments when executing the program.

Correspondingly, embodiments of the present disclosure further provide a storage medium. The storage medium has instructions stored thereon. When the instructions are executed by a computer, the computer is caused to implement the method for controlling a virtual speech assistant according to the above embodiments.

One skilled in the art should understand that, embodiments of the present disclosure may provide a method, system, or a computer program product. Therefore, the present disclosure may take the form of an entirely hardware embodiment, an entirely software embodiment, or an embodiment combining with software and hardware. And, the present disclosure may take the form of a computer program product implemented in one or more computer readable storage mediums (including but not limited to a disk memory, CD-ROM (compact disc read-only memory), an optical memory, etc.) including computer usable program codes.

The present disclosure is described with reference to flow charts and/or block diagrams according to the method, the device (system), and the computer program product of the embodiments of the present disclosure. It should be understood that the computer program instructions implement each flow and/or each block in the flow charts and/or block diagrams and a combination of flows and/or blocks in the flow charts and/or block diagrams. These computer program instructions may be provided to a processor of a general purpose computer, a special purpose computer, an embedded processor, or other programmable data processing device to generate a machine, such that an apparatus for implementing a specific function at one or more flows in the flow charts and/or one or more blocks in the block diagrams is generated by instructions executed by the processor of the computer or other programmable data processing device.

These computer program instructions may be stored in a computer readable memory which may guide the computer or other programmable data processing device to work in a specific way, such that the instructions stored in the computer readable memory include a product of an instruction apparatus. The instruction apparatus implements the specific function at the one or more flows in the flow charts and/or the specific function at the one or more blocks in the block diagrams.

These computer program instructions may be loaded in the computer or other programmable data processing device, such that a series of steps are executed in the computer or other programmable data processing device to generate processing implemented by the computer, and the instructions executed in the computer or other programmable data processing device provide steps for implementing the specific function at the one or more flows in the flow charts and/or the specific function at the one or more blocks in the block diagrams.

In a typical configuration, the computer device includes one or more processors (CPU), an input/output interface, a network interface and an internal memory.

The memory may include a non-persistent memory, a random access memory (RAM), and/or a non-volatile memory in a computer readable medium, such as a random only memory (ROM) or a flash RAM. The memory is an example of the computer readable medium.

The computer readable medium includes a permanent and non-permanent medium, removable and non-removable medium implemented in any method or technology for storing information. The information may be computer readable instructions, data structures, program modules or other data. The examples of the computer storage medium may include, but not be limited to, a phase change random access memory (PRAM), a static RAM (SRAM), a dynamic RAM (DRAM), other types of RAMs (random access memory), a ROM (read only memory), an erasable programmable read-only memory (EPROM), a flash memory or other memory technology, CD-ROM, digital versatile disc (DVD) or other optical disc storage, magnetic cartridge, magnetic tape, magnetic disk storage or other magnetic storage device, or any other non-transmission medium used for storing and accessed by the computer device. As defined in the application, the computer readable medium does not include a transitory computer readable media, such as a modulated data signal and a carrier wave.

It should also be noted that, for purpose of this disclosure, the terms “include” and “including” are meant to be synonymous with “comprise” or “comprising,” or any other variations thereof and are intended to cover a non-exclusive inclusion, such that the process, the method, the product or the device including a series of elements not only includes those elements, but also includes other elements not listed explicitly, or also includes elements inherent in the process, the method, the product or the device. Without more restrictions, for the element defined by the sentence “including one . . . ”, it is not excluded that there are other same elements in the process, the method, the product or the device including the element.

One skilled in the art should understand that, embodiments of the present disclosure may provide a method, a system or a computer program product. Therefore, the present disclosure may take the form of an entirely hardware embodiment, an entirely software embodiment, or an embodiment combining with software and hardware. And, the present disclosure may take the form of a computer program product implemented in one or more computer readable storage mediums (including but not limited to a disk memory, CD-ROM, an optical memory, etc.) including computer usable program codes.

The above is embodiments of the present disclosure, which is not used to limit the present disclosure. For the skilled in the art, the present disclosure may make any movement and change. Any modification, equivalent and improvement within the spirit and scope of the present disclosure fall within the scope of the claims of the present disclosure.

What is claimed is:

1. A method for controlling a virtual speech assistant, comprising:
displaying a virtual speech assistant icon in a floating way on a human-machine interaction interface of a user device;
receiving a speech instruction when a microphone of the user device is enabled; and
performing an operation according to the speech instruction, and producing a speech output corresponding to an operation result of the operation.

2. The method of claim 1, after receiving the speech instruction, further comprising:
displaying a dialog box in the floating way, and displaying a text corresponding to the speech instruction in the dialog box.

3. The method of claim 1, wherein, performing the operation according to the speech instruction and producing the speech output corresponding to the operation result of the operation comprises:
performing the operation according to the speech instruction; and
producing the speech output corresponding to the operation result of the operation, and displaying the virtual speech assistant icon dynamically according to the operation result.

4. The method of claim 1, further comprising:
displaying the virtual speech assistant icon dynamically according to a setup of a preset reminder message when the user device is enabled, wherein, the preset reminder message comprises at least one of a festival, a solar term, news or weather information.

5. The method of claim 1, wherein, the virtual speech assistant icon is displayed in a set area of the human-machine interaction interface.

6. The method of claim 5, further comprising:
hiding or half-hiding the virtual speech assistant icon when an instruction for dragging the virtual speech assistant icon out of the set area is received; and
displaying the virtual speech assistant icon in the set area when a hiding-cancelling instruction is received.

7. The method of claim 1, further comprising:
displaying the virtual speech assistant icon dynamically when no speech instruction is received within a preset period.

8. The method of claim 3, wherein, displaying the virtual speech assistant icon dynamically comprises displaying at least one of expression changes, movement changes, changes of clothes, or a bubble display of the virtual speech assistant icon.

9. The method of claim 1, wherein, when the virtual speech assistant icon is displayed in the floating way on the human-machine interaction interface, a preset priority of the virtual speech assistant icon with respect to an application that is running on the human-machine interaction interface is used for reference,
when the priority of the virtual speech assistant icon is above that of the application that is running on the human-machine interaction interface, the virtual speech assistant icon is displayed in a floating way on the human-machine interaction interface, and
when the priority of the virtual speech assistant icon is lower than that of the application that is running on the human-machine interaction interface, the application that is running on the human-machine interaction interface is displayed by overlaying it over the virtual speech assistant icon.

10. An apparatus for controlling a virtual speech assistant, comprising:
one or more processors, and
a storage device, configured to store one or more programs,
wherein, when the one or more programs are executed by the one or more processors, the one or more processors are configured to implement method for controlling a virtual speech assistant, comprising:
displaying a virtual speech assistant icon in a floating way on a human-machine interaction interface of a user device;
receiving a speech instruction when a microphone of the user device is enabled; and
performing an operation according to the speech instruction, and producing a speech output corresponding to an operation result of the operation.

11. The apparatus of claim 10, wherein the one or more processors are further configured to, after receiving the speech instruction,
display a dialog box in the floating way, and display a text corresponding to the speech instruction in the dialog box.

12. The apparatus of claim 10, wherein, when the one or more processors are configured to perform the operation according to the speech instruction and produce the speech output corresponding to the operation result of the operation, the one or more processors are configured to:
perform the operation according to the speech instruction; and
produce the speech output corresponding to the operation result of the operation, and display the virtual speech assistant icon dynamically according to the operation result.

13. The apparatus of claim 10, wherein the one or more processors are further configured to:
display the virtual speech assistant icon dynamically according to a setup of a preset reminder message when the user device is enabled, wherein, the preset reminder message comprises at least one of a festival, a solar term, news or weather information.

14. The apparatus of claim 10, wherein, the virtual speech assistant icon is displayed in a set area of the human-machine interaction interface.

15. The apparatus of claim 14, wherein the one or more processors are further configured to:
hide or half-hide the virtual speech assistant icon when an instruction for dragging the virtual speech assistant icon out of the set area is received; and
display the virtual speech assistant icon in the set area when a hiding-cancelling instruction is received.

16. The apparatus of claim 10, wherein the one or more processors are further configured to:
display the virtual speech assistant icon dynamically when no speech instruction is received within a preset period.

17. The apparatus of claims 12, wherein, when the one or more processors are configured to display the virtual speech assistant icon dynamically, the one or more processors are configured to display at least one of expression changes, movement changes, changes of clothes, or a bubble display of the virtual speech assistant icon.

18. A non-transitory storage medium having instructions stored thereon that, when executed by a computer, causes the computer to implement a method for controlling a virtual speech assistant, comprising:
displaying a virtual speech assistant icon in a floating way on a human-machine interaction interface of a user device;
receiving a speech instruction when a microphone of the user device is enabled; and
performing an operation according to the speech instruction, and producing a speech output corresponding to an operation result of the operation.
